(19) United States
(12) Patent Application Publication
(10) Pub. No.: US 2009/0023528 A1
(43) Pub. Date: Jan. 22, 2009

(54) Motorcycle Chain Guide and Tensioner

(76) Inventor: James A. Dickson, Boswell, OK (US)

Correspondence Address: WILSON DANIEL SWAYZE, JR., 3804 CLEARWATER CT., PLANO, TX, 75025, US

(21) Appl. No.: 12/176,355

(22) Filed: Jul. 19, 2008

Related U.S. Application Data
(60) Provisional application No. 60/961,332, filed on Jul. 20, 2007.

(51) Int. Cl. F16H 7/12

(52) U.S. Cl. 474/135

(57) ABSTRACT

A chain guide and tensioner for guiding and applying tension to a chain may include a first tensioner arm, a second tensioner arm being positioned in a spaced relationship with respect to the first arm member, a shaft member for connection to the first arm member, and a roller member including a groove for guiding the chain. The roller member may include a pair of opposing flanges to define the groove and the height of the opposing flanges may be at least the height of the chain. The first tensioner arm may be biased by a biasing member, and the biasing member may include a spring. The biasing member may include a shock absorber, and the roller member may be positioned by a collar member. The collar member may move along a roller bushing member to adjust the roller member to be aligned with the chain, and the spring may be positioned over a spring bushing member. The spring bushing member may maintain a spaced relationship between the first tensioner arm and the second tensioner arm, and the second tensioner arm may be connected to the vehicle. The flange may include a chamfered edge.

### PRIORITY

The present invention claims priority based on the provisional application which was filed on Jul. 20, 2007 with a Ser. No. of 60/961,332.

Various forms of chain tensioning devices have been heretofore designed for use in conjunction with motorcycle chains as well as drive chains found in other environments. When a chain tensioner is used on a motorcycle equipped with swing arm suspension for the rear wheel of the motorcycle, The chain tightener may be located closely forward of the lower forward quadrant of the driven sprocket carried by the rear wheel of the motorcycle. In this manner, minimum shifting of the chain relative to the mounting portion on the adjacent swing arm for the chain tightener in response to oscillation of the swing arm is experienced and the chain tightener may more readily effect more even tension on the chain even when the motorcycle is traveling at high speeds over rough terrain.

While many of the previously designed chain tensioners are operative to perform the desired chain tensioning operation under other than severe conditions, most previously provided chain tensioners do not perform well under adverse conditions.

Examples of various forms of previously patented chain tensioners are disclosed in U.S. Pat. Nos. 3,136,170, 3,198,025, 3,673,884, 3,834,246, 3,834,477 and 3,838,606. Other relevant prior art includes U.S. Pat. No. 3,838,606 October 1974 to Scalise, U.S. Pat No. 5,679,084 October 1997 to Daniels and U.S. Pat. No. 4,036,069 July 1977 Clark.

U.S. Pat. No. 4,036,069 discloses a mounting plate being provided for removable rigid support from and in overlapped engagement with the lower marginal portion of a mount flange carried by the rear swing arm of a motorcycle adjacent to which the motorcycle chain is trained. A pivot shaft has one end portion removably rigidly secured through the plate and one pair of corresponding ends of parallel arms are mounted on the pivot shaft for oscillation relative thereto. A roller is journaled between the other pair of corresponding ends of the parallel arms and spring structure is operatively connected between one of the arms and the mounting plate for yieldingly biasing the arms in one direction of angular displacement about the pivot shaft, the chain of the associated motorcycle being receivable between the end portions of the arms between which the roller is journaled and with the chain passing over the roller.

### SUMMARY

A chain guide and tensioner for guiding and applying tension to a chain may include a first tensioner arm, a second tensioner arm being positioned in a spaced relationship with respect to the first arm member, a shaft member for connection to the first arm member, and a roller member including a groove for guiding the chain.

The roller member may include a pair of opposing flanges to define the groove and the height of the opposing flanges may be at least the height of the chain.

The first tensioner arm may be biased by a biasing member, and the biasing member may include a spring.

The biasing member may include a shock absorber, and the roller member may be positioned by a collar member.

The collar member may move along a roller bushing member to adjust the roller member to be aligned with the chain, and the spring may be positioned over a spring bushing member.

The spring bushing member may maintain a spaced relationship between the first tensioner arm and the second tensioner arm, and the second tensioner arm may be connected to the vehicle.

The flange may include a chamfered edge.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the a motorcycle chain guide and tensioner in accordance with the present invention; and

FIG. 2 illustrates an exploded view of the motorcycle chain guide and tensioner of the present invention.

### DETAILED DESCRIPTION

Most motorcycles are chain driven in that a continuous chain is used to connect the motor with the drive wheel. Needless to say, it can be a great inconvenience if the chain is disconnected from the drive wheel during the normal operation of the motorcycle. Furthermore, it is desirable to maintain a predetermined tension on the chain in order to provide near optimal operation. The present invention seeks to achieve these goals. The present invention may include a motorcycle chain guide and tensioner that substantially eliminates the possibility of the chain slipping off of the tensioner during operation. This problem especially manifests itself during racing conditions. A number of racing enthusiasts have experienced a problem with the chain slipping off during the extreme conditions involved in racing.

The present invention assists in maintaining a continuous loop, drive chain for a motorcycle or similar vehicle in a substantially taut condition. The roller which cooperates with the chain may include a groove defined by a pair of opposing flanges that may act as a guide for the chain as well as preventing the chain from slipping off the roller. The roller may be attached to an arm that is spring biased to put pressure on the chain between the at least two chain sprockets to maintain the chain taut. The roller may be positioned between at least two shaft collars that allow the roller to be centered to the chain.

The present invention provides many advantages including that the present invention will substantially eliminate the possibility of the chain slipping off of the tensioner by the use of a grooved roller that has sides or flanges extending outwardly or radially at least the height of the seated chain.

Another advantage of the present invention may be that the roller can be adjusted to be center to the chain by use of the shaft collars.

Furthermore, another advantage may be the low cost of manufacturing with regard to both materials and labor, and which correspondingly may result in lower prices for the purchaser. The present invention may be economically available to the buying public.

Drawings—Reference Numerals:
10—grooved roller member
12—shaft collar member
14—shaft member
16—first tensioner arm
18—torsion spring member
20—second tensioner arm
22—bolt
24—nut
26—nut
28—spring bushing member
30—roller bushing member

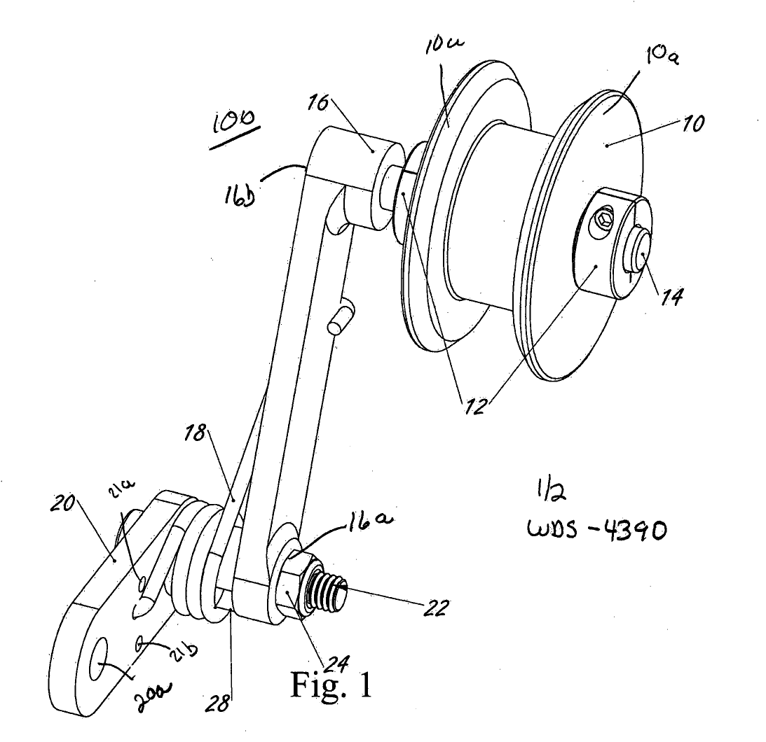

FIG. 1. provides a perspective view of the motorcycle chain guide and tensioner 100 which may be illustrated as an assembled motorcycle chain guide and tensioner 100. The tensioner 100 may be used on motorcycles, bicycles, automobiles, trucks, boats or other types of vehicles requiring a chain guide and tensioner.

The motorcycle chain guide and tensioner 100 may include a first tensioner arm 16 and a second tensioner arm 20 which may be mounted to the motorcycle or other vehicle by an aperture 20a or a multitude of apertures. The second tensioner arm 20 may be connected to the first tensioner arm 16 by an attachment member which may include a bolt 22 and nut 26. The tensioner 100 may include a spring bushing member 28 to maintain the first tensioner arm 16 and the second tensioner arm 20 at a spaced relationship and to cooperate with a biasing apparatus which may include a spring member 18 to bias the first tensioner arm 16. The biasing apparatus may include a spring member 18, a shock member and strut (not shown). The bias may be adjusted to apply more or less bias by affixing an end of the spring member 18 within a first biasing aperture 21a or a second biasing aperture 21b which may be formed within the second tensioner arm 20. Multiple biasing apertures may be provided. The spring bushing member 28 cooperates with the bolt 22 and nut 26 to retain the first tensioner arm 16, the second tensioner arm 20 and the spring bushing member 28. The first tensioner arm 16 may include a first aperture 16a at one end of the first tensioner arm 16 and which extends through the first tensioner arm 16 to cooperate with the spring bushing member 28 to allow the first tensioner arm 16 to rotate or pivot based upon the force of the chain interacting with the roller member 10 and the spring member 18.

The first tensioner arm 16 may include a second aperture 16b at the other end of the first tensioner arm 16 to cooperate with the shaft member 14. The shaft member 14 may cooperate with a pair of apertures formed in a pair of opposed shaft collar members 12 and a roller bearing member 30 which may be positioned between the collar members 12. The position of the collar members 12 may be axially adjusted to adjust the position of the roller member 10 in order to be aligned with the chain of the motorcycle. The roller bearing member 30 may allow the roller member 10 to rotate, and the roller member 10 may include a groove which may be defined by a pair of opposing flanges 10a. The opposing flanges 10a may be sufficiently high in order to prevent a chain of the motorcycle from leaving the groove. More particularly, the opposing flanges 10a may have a radial height which may be equal to or greater than the height of a motorcycle chain. The opposing flanges 10a may include a chamfered surface 10b in order to urge the chain inwards. In addition, bearings which may be lubricated or sealed or other friction reducing devices may be included to increase performance and longevity.

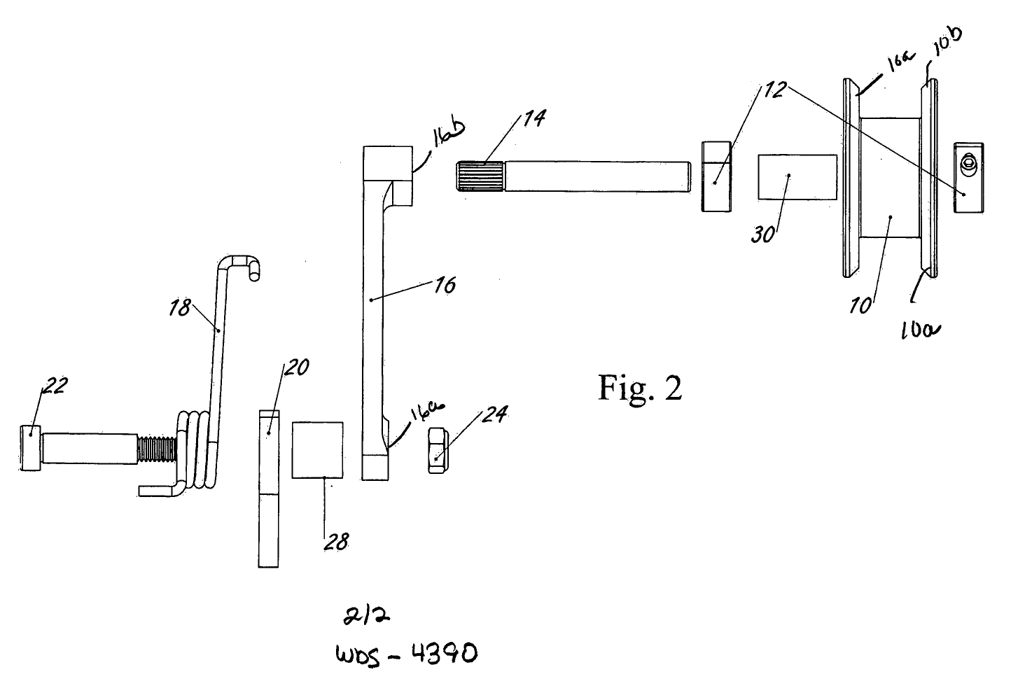

FIG. 2. provides an exploded view of the motorcycle chain guide and tensioner 100.

As shown in FIG. 2, the motorcycle chain guide and tensioner 100 may include a first tensioner arm 16 and a second tensioner arm 20 which may be mounted to the motorcycle or other vehicle by an aperture 20a or a multitude of apertures. The second tensioner arm 20 may be connected to the first tensioner arm 16 by an attachment member which may include a bolt 22 and nut 26. The tensioner 100 may include a spring bushing member 28 to maintain the first tensioner arm 16 and the second tensioner arm 20 at a spaced relationship and to cooperate with a biasing apparatus which may include a spring member 18. The biasing apparatus may include a spring member 18 and a shock member (not shown). The spring bushing member 28 cooperates with the bolt 22 and nut 26 to retain the first tensioner arm 16, the second tensioner arm 20 and the spring bushing member 28. The first tensioner arm 16 may include a first aperture 16a at one end of the first tensioner arm 16 and which extends through the first tensioner arm 16 to cooperate with the spring bushing member 28 to allow the first tensioner arm 16 to rotate or pivot based upon the force of the chain interacting with the roller member 10 and the spring member 18.

The first tensioner arm 16 may include a second aperture 16b at the other end of the first tensioner arm 16 to cooperate with the shaft member 14. The shaft member 14 may cooperate with a pair of apertures formed in a pair of opposed shaft collar members 12 and a roller bearing member 30 which may be positioned between the collar members 12. The roller bearing member 30 may allow the roller member 10 to rotate, and the roller member 10 may include a groove which may be defined by a pair of opposing flanges 10a. The opposing flanges 10a may be sufficiently high in order to prevent a chain of the motorcycle from leaving the groove. More particularly, the opposing flanges 10a may have a radial height which may be equal to or greater than the height of a motorcycle chain. The opposing flanges 10a may include a chamfered surface 10b in order to urge the chain inwards.

Operation:

The user will attach the motorcycle chain guide and tensioner 100 to their motorcycle or similar vehicle by attaching the second tensioner arm 20 to the motorcycle by a bolt for example through the aperture 20a. The motorcycle chain is attached to the motorcycle and the first tensioner arm 16 is rotated or pivots to allow the chain to be placed in the groove of the roller member 10. The spring member 18 rotates the first tensioner arm 16 to take any play out of the chain and to maintain a predetermined tension or force on the chain. The opposing flanges 10a operate to keep the chain within the channel or groove of the roller member 10. In order to center the chain within the channel, the collar members can be moved along the shaft member 14. One and the chain is centered within the channel or groove of the roller member 10, the collar members 12 are fastened to the shaft member 14 with the fastening device such as set screws in order to maintain the roller member 10 in position.

Alternatively, a spring and shock could be used to further decrease the possibility of the chain slipping off of the tensioner 100 and ultimately off of the sprockets of the motorcycle.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A chain guide and tensioner for guiding and applying tension to a chain, comprising:
a first tensioner arm;
a second tensioner arm being positioned in a spaced relationship with respect to the first arm member;
a shaft member for connection to the first arm member;
a roller member including a groove for guiding the chain;
wherein the roller member includes a pair of opposing flanges to define the groove and wherein the height of the opposing flanges is at least the height of the chain.

2. A chain guide and tensioner for guiding and applying tension to a chain as in claim 1, wherein the first tensioner arm is biased by a biasing member.

3. A chain guide and tensioner for guiding and applying tension to a chain as in claim 2, wherein the biasing member includes a spring.

4. A chain guide and tensioner for guiding and applying tension to a chain as in claim 3, wherein the biasing member includes a shock absorber.

5. A chain guide and tensioner for guiding and applying tension to a chain as in claim 1, wherein the roller member is positioned by a collar member.

6. A chain guide and tensioner for guiding and applying tension to a chain as in claim 5, wherein the collar member moves along a roller bushing member to adjust the roller member to be aligned with the chain.

7. A chain guide and tensioner for guiding and applying tension to a chain as in claim 3, wherein the spring is positioned over a spring bushing member.

8. A chain guide and tensioner for guiding and applying tension to a chain as in claim 7, wherein the spring bushing member maintains a spaced relationship between the first tensioner arm and the second tensioner arm.

9. A chain guide and tensioner for guiding and applying tension to a chain as in claim 1, wherein the second tensioner arm is connected to the vehicle.

10. A chain guide and tensioner for guiding and applying tension to a chain as in claim 1, wherein the flange includes a chamfered edge.
